(19) United States
(12) Patent Application Publication
(10) Pub. No.: US 2025/0388150 A1
(43) Pub. Date: Dec. 25, 2025

(54) BACK PANEL

(71) Applicant: TOYOTA BOSHOKU KABUSHIKI KAISHA, Aichi (JP)

(72) Inventors: Kimiyasu KUROKAWA, Gifu (JP); Hayato ISHII, Aichi (JP)

(73) Assignee: TOYOTA BOSHOKU KABUSHIKI KAISHA, Aichi (JP)

(21) Appl. No.: 19/241,662

(22) Filed: Jun. 18, 2025

(30) Foreign Application Priority Data
Jun. 21, 2024 (JP) 2024-100257

(51) Int. Cl. B60N 2/68

(52) U.S. Cl. CPC B60N 2/686

(57) ABSTRACT

One aspect of the present disclosure provides a back panel that (i) includes a substantially plate shaped panel body and a curled portion and (ii) is configured to be part of a back frame of a vehicle seat. The curled portion is (i) provided at at least a portion of an outer edge of the panel body and (ii) curved in an arc shape.

### CROSS-REFERENCE TO RELATED APPLICATIONS

The present application claims the benefit of Japanese Patent Application No. 2024-100257 filed on Jun. 21, 2024 with the Japan Patent Office, the entire disclosure of which is incorporated herein by reference.

### BACKGROUND

The present disclosure relates to a back panel for a back frame of a vehicle seat.

Japanese Unexamined Patent Application Publication No. 2015-074390 discloses a back panel. As shown in FIG. 6 of the publication, the outer edge of this back panel is provided with a flange extending in a direction orthogonal to the plate surface of the back panel. In other words, the cross-section of the outer edge of the back panel has a substantially L-shape.

### SUMMARY

Many back panels with a substantially L-shaped outer edge have a configuration in which the flange of the outer edge is covered with a resin cover. In one aspect of the present disclosure, it is desirable that a cover can be eliminated from a back panel.

One aspect of the present disclosure may provide a back panel comprising at least any one of:
Feature 1: a panel body having a substantially plate shape;
Feature 2: a curled portion (i) provided at (or provided on, or provided along) at least a portion of an outer edge of the panel body and (ii) curved in an arc shape; and
Feature 3: the back panel is configured to be part of a back frame of a vehicle seat.

In the back panel comprising at least Features 1 and 2 (or at least Features 1 through 3), it is possible to improve rigidity of the panel body and inhibit a sharp portion from being created at the outer edge of the panel body. As a result, a cover can be eliminated from the back panel.

The back panel may comprise, in addition to or in place of at least any one of Features 1 through 3,
Feature 4: a connecting portion (i) connecting the curled portion with the panel body and (ii) curved in a front-rear direction of the vehicle seat.

The back panel may comprise, in addition to or in place of at least any one of Features 1 through 4, at least any one of:
Feature 5: the connecting portion is curved in an arc shape; and
Feature 6: a hypothetical tangent circle tangent to the curled portion and the connecting portion has a radius larger than a radius of curvature of the curled portion and a radius of curvature of the connecting portion.

### BRIEF DESCRIPTION OF THE DRAWINGS

Some example embodiments of the present disclosure will be described below with reference to the accompanying drawings, in which:

FIG. 1 shows a back frame according to a first embodiment;

FIG. 2 is an exploded view of the back frame according to the first embodiment;

FIG. 3 shows a panel body according to the first embodiment;

FIG. 4 shows a curled portion according to the first embodiment; and

FIG. 5 shows an enclosure frame according to the first embodiment.

### DETAILED DESCRIPTION OF EXEMPLARY EMBODIMENTS

Below-described embodiments show examples of embodiments that fall within the technical scope of the present disclosure. That is, the appended claims are not limited to specific configurations, structures, and so on indicated in the embodiments below.

The embodiments below are examples in which a back panel according to the present disclosure is applied to a seat to be mounted in a vehicle such as an automobile (hereinafter, referred to as a “vehicle seat”). Arrows indicating directions, hatched lines, and so on shown in the drawings are provided for the purpose of easier understanding of mutual relationships between the drawings, shapes of members or portions, and so on.

Thus, the back panel is not limited to be oriented as shown in the drawings. The drawings provided with hatched lines do not necessarily represent sectional views.

A member or a portion described at least with a reference numeral is at least one in number except in a case of being accompanied by restrictive words such as “only one”. In other words, the member or the portion may be two or more in number in a case of not being accompanied by the restrictive words such as “only one”. The back panel disclosed in the present disclosure comprises at least one of (i) an element such as the member or the portion described at least with a reference numerical or (ii) a structural portion shown in the drawings.

### First Embodiment

### <1. Overview of Seatback>

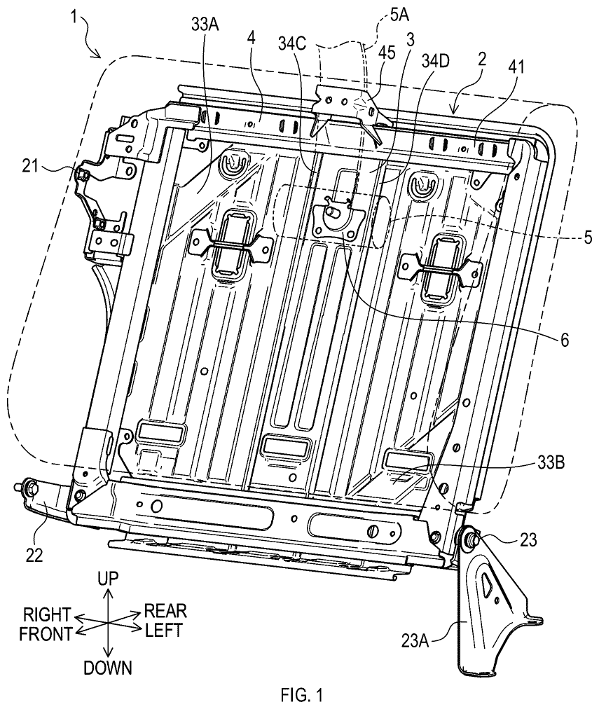

FIG. 1 illustrates a seatback 1 according to the present embodiment which is used for a rear seat of an automobile. The seatback 1 is configured to support an occupant's back. The seatback 1 comprises a back frame 2, a cushion (not shown), and a cover portion (not shown).

The back frame 2 is a strength member forming a framework of the seatback 1. The cushion is a shock-absorbing member made of foamed urethane, for example. The cover portion is a member covering the cushion and the back frame 2.

The back frame 2 comprises a fixed portion 21, a first coupling portion 22, and a second coupling portion 23. The fixed portion 21 is configured to be fixed to the vehicle and arranged in an upper portion of one side of the back frame 2 in a width direction of the back frame 2 (on the upper right side, in the present embodiment).

Specifically, the fixed portion 21 is where a latch device (not shown) is to be mounted. The latch device is configured to be engaged with a striker (not shown) in the vehicle. The latch device can be switched between an engaged state and a disengaged state. In the engaged state, the latch device is engaged with the striker. In the disengaged state, the latch device is disengaged from the striker.

The first coupling portion 22 and the second coupling portion 23 are configured to be rotatably coupled to the vehicle. The first coupling portion 22 is arranged in a lower portion of the one side (the right side, in the present embodiment) of the back frame 2 in the width direction.

The second coupling portion 23 is arranged in a lower portion of the opposite side (the left side, in the present embodiment) of the back frame 2 in the width direction. The second coupling portion 23 is configured to be coupled to the vehicle via a bracket 23A.

In the engaged state where the latch device is engaged with the striker, the seatback 1 is held in the vehicle in a standing manner as shown in FIG. 1. When the latch device is disengaged from the striker, the seatback 1 becomes rotatable about the first coupling portion 22 and the second coupling portion 23 so as to be tilted forward.

### <2. Configuration of Back Frame>

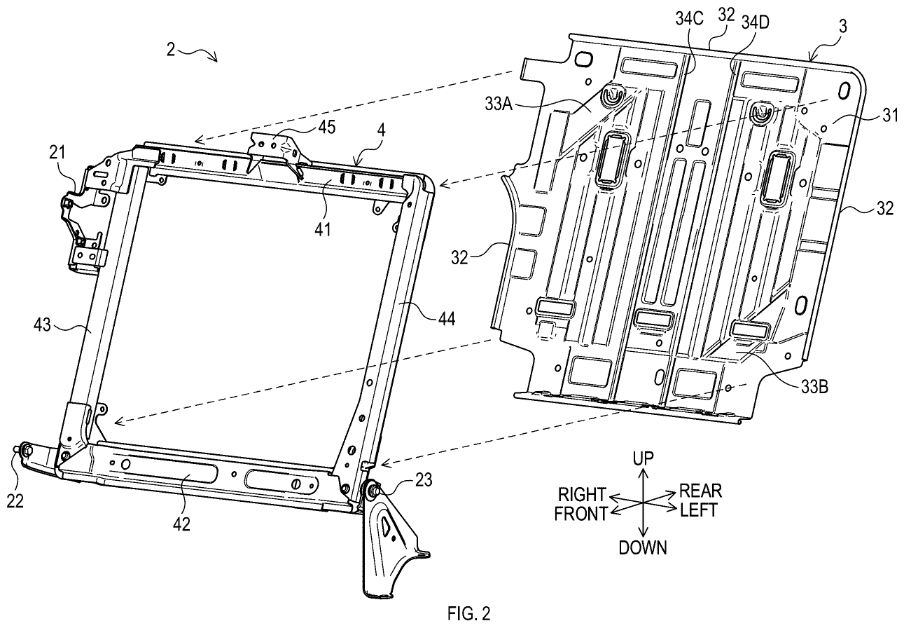

As shown in FIG. 2, the back frame 2 comprises at least a back panel 3 and an enclosure frame 4. The back panel 3 is a metal panel in the form of a substantially rectangular plate. The enclosure frame 4 is a metal framework in the form of a rectangular frame. The enclosure frame 4 is joined to the back panel 3 (specifically, a panel body 31 which will be described below) by welding.

### <2.1 Details of Back Panel>

The back panel 3 comprises at least the panel body 31 and a curled portion 32. In the present embodiment, the panel body 31 (including a bead portion 33 and a bead portion 34 to be described below) and the curled portion 32 are portions of a single metal plate plastically deformed.

### <<Panel Body>>

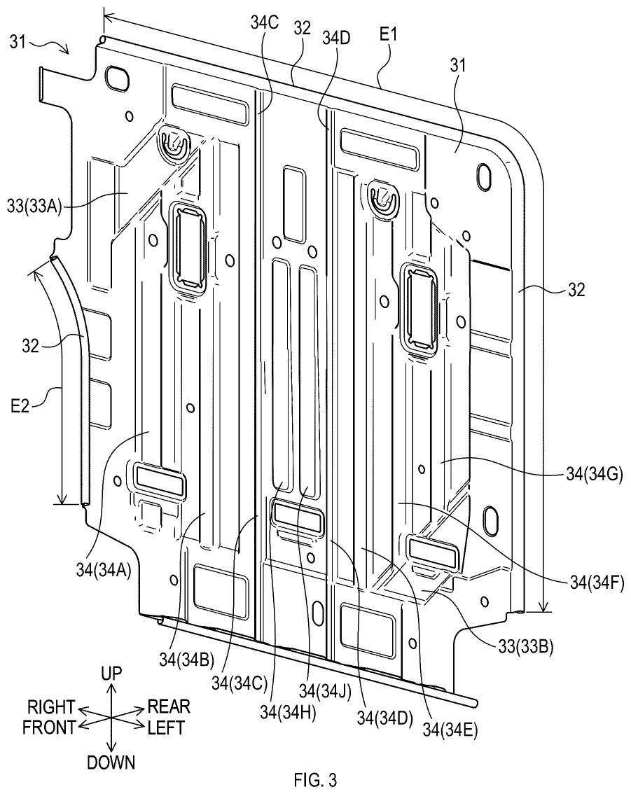

As shown in FIG. 3, the panel body 31 is a portion in the form of a substantially rectangular plate provided with the bead portions 33 and 34. Each of the bead portions 33 and 34 is in the form of an elongated protrusion raised in a direction along the thickness of the panel body 31 from a plate surface of the panel body 31.

The bead portion 33 includes a first diagonal bead portion 33A and a second diagonal bead portion 33B. As shown in FIG. 1, the first diagonal bead portion 33A is arranged on the panel body 31, that is the back panel 3, at a position close to the fixed portion 21. The first diagonal bead portion 33A is in the form of an elongated protrusion extending in a diagonal direction inclined with respect to a seat-width direction and an up-down direction.

The second diagonal bead portion 33B is arranged on the panel body 31, that is the back panel 3, at a position diagonally opposite the first diagonal bead portion 33A. The second diagonal bead portion 33B is in the form of an elongated protrusion extending in the diagonal direction.

In other words, the first diagonal bead portion 33A is a brace-like bead portion that connects the upper side and the right side of the back panel 3 to each other. The second diagonal bead portion 33B is a brace-like bead portion that connects the lower side and the left side of the back panel 3 to each other.

The bead portions 34 includes vertical bead portions 34A through 34H and 34J, each of which is in the form of an elongated protrusion extending in the up-down direction. The vertical bead portions 34A through 34H and 34J extend in a front-rear direction of the vehicle, when viewed in a tilted-down state of the seatback 1.

The panel body 31, that is the back panel 3, according to the present embodiment is provided with a mounting portion 6 (see FIG. 1) to which a retractor 5 is to be mounted. The retractor 5 is a device configured to wind up a seat belt webbing (belt portion) 5A.

Out of the vertical bead portions 34A through 34H and 34J, the vertical bead portions 34C and 34D adjacent to the mounting portion 6 extend to the respective positions to be overlapped by an upper beam portion 41 which will be described later. Specifically, the vertical bead portions 34C and 34D extend to the upper edge of the panel body 31 as shown in FIG. 3.

The vertical bead portions 34C and 34D extend at least from a portion of the panel body 31 below the lower end of the mounting portion 6 to the upper edge of the panel body 31. The vertical bead portions 34C and 34D according to the present embodiment extend from the bottom edge to the upper edge of the panel body 31.

### <<Curled Portion>>

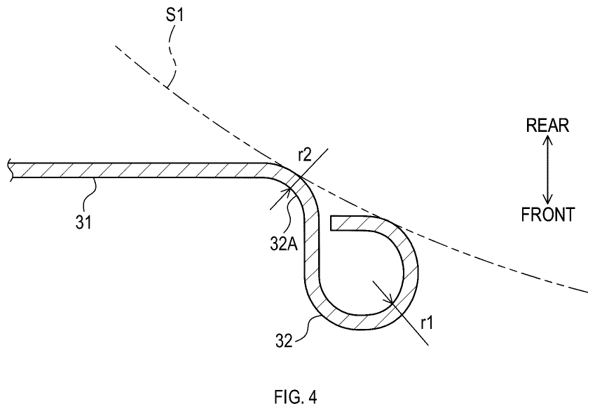

As shown in FIG. 4, the curled portion 32 is a portion in which the outer edge of the panel body 31 is curved in an arc shape. The phrase of “curved in an arc shape” mentioned immediately before refers to a structure in which the angle of the arc is, for example, 180 degrees or greater (270 degrees or greater in the present embodiment).

As shown in FIG. 3, the curled portion 32 is provided at at least a portion of the outer edge of the panel body 31 (at outer edge portions E1, E2 in the present embodiment). As shown in FIG. 4, the entire curled portion 32 is arranged at a position displaced in a front-rear direction of the seat (deviates in the forward direction, in the present embodiment) from an imaginary line extending from the panel body 31.

The curled portion 32 and the panel body 31 are connected via a connecting portion 32A. The connecting portion 32A is curved in an arc shape in the forward direction. A hypothetical tangent circle S1 tangent to the curled portion 32 and the connecting portion 32A has a radius larger than a radius of curvature r1 of the curled portion 32 and a radius of curvature r2 of the connecting portion 32A.

### <2.2 Details of Enclosure Frame>

As shown in FIG. 2, the enclosure frame 4 is in the form of a rectangular frame extending along the outer edge of the panel body 31. Specifically, the enclosure frame 4 comprises the upper beam portion 41, a lower beam portion 42, a first side frame 43 and a second side frame 44.

The upper beam portion 41 is a frame joined to the upper end of the back panel 3, that is the panel body 31, and extending in the seat-width direction. On the upper beam portion 41, a receiving portion 45 is arranged. As can be seen from FIG. 1, the receiving portion 45 is configured to receive a tensile force that acts on the webbing 5A.

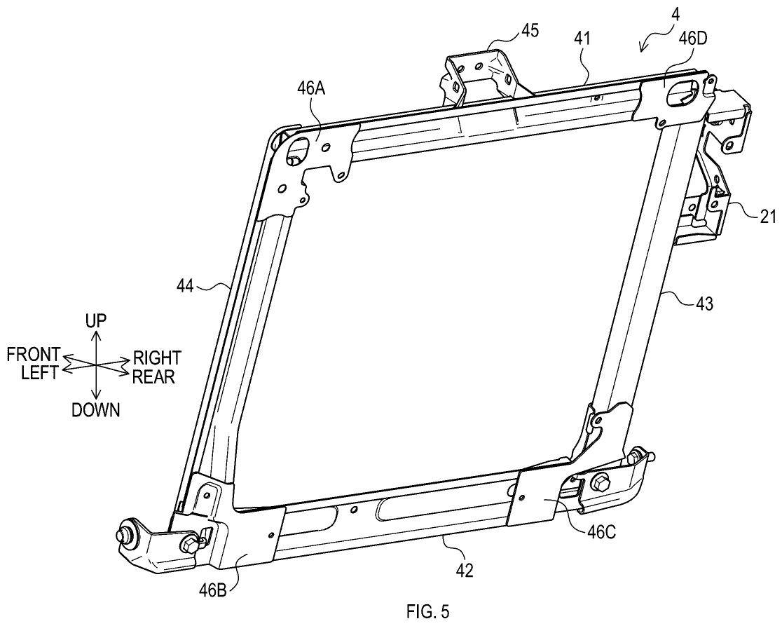

As shown in FIG. 5, the receiving portion 45 of the present embodiment forms, together with the upper beam portion 41, a rectangular closed curve frame portion into which the webbing 5A is to be inserted. The tensile force that acts on the receiving portion 45 is transmitted to the back frame 2 via the upper beam portion 41.

As shown in FIG. 2, the lower beam portion 42 is a frame joined to the lower end of the panel body 31 and extending in the seat-width direction. The first side frame 43 and the second side frame 44 are coupled to the respective ends of the upper beam portion 41 in the extending direction of the upper beam portion 41 and the respective ends of the lower beam portion 42 in the extending direction of the lower beam portion 42.

As shown in FIG. 5, gusset plates 46A through 46D are joined to portions of the enclosure frame 4 in which the upper beam portion 41, the lower beam portion 42, the first side frame 43, and the second side frame 44 are connected. The gusset plates 46A through 46D are reinforcing plates that strengthen the respective connections.

In the present embodiment, each of the upper beam portion 41, the lower beam portion 42, and the second side frame 44 has a substantially C-shape cross-section or a substantially angular C-shape cross-section that is open in its rear side. The opening in each cross-section is closed with the panel body 31.

The first side frame 43 has a cross-section that independently forms a closed rectangular shape. This is because the fixed portion 21 is arranged on the first side frame 43. The panel body 31 of the present embodiment is joined also to the back surface of the first side frame 43.

### <3. Features of Panel Body of Present Embodiment>

In the panel body 31 of the present embodiment, the curled portion 32 curved in an arc shape is provided at at least a portion of the outer edge of the panel body 31.

This configuration can improve rigidity of the panel body 31 and inhibit a sharp portion from being created at the outer edge of the panel body 31. Furthermore, this configuration can eliminate the need for a cover.

### Other Embodiments

In the above-described embodiment, the curled portion 32 is provided only at a portion of the outer edge of the panel body 31. However, the present disclosure is not limited to this configuration. The curled portion 32 may be provided on the entire outer edge of the panel body 31, for example.

In the above-described embodiment, the curled portion 32 is positioned on the front side of the panel body 31. However, the present disclosure is not limited to this configuration. The curled portion 32 may be positioned on the rear side of the panel body 31, or the center of the curled portion 32 may be positioned at a position on the imaginary line extending from the panel body 31, for example.

In the above-described embodiment, the panel body 31 is provided with the bead portions 33 and 34. However, the respective positions, the respective extending directions, and so on of the bead portions 33 and 34 of the present disclosure are not limited to the configuration illustrated in FIG. 1 or described in other portions in the present disclosure.

In the above-described embodiments, the vehicle seat according to the present disclosure is mounted in the automobile. However, the present disclosure is not limited to this configuration. The present disclosure is also applicable to, for example, a seat used in a vehicle such as a railroad vehicle, a ship, a boat, or an aircraft, and also to a stationary seat used in a theater, at home, or in another place.

Moreover, the present disclosure only needs to be consistent with the gist of the disclosure described in the above-described embodiments, and is not limited to the above-described embodiments. Therefore, a configuration may be employed in which at least two embodiments among the above-described embodiments are combined together or in which any of the elements shown in the drawings or the elements described with reference numerals is eliminated in the above-described embodiments.

What is claimed is:

1. A back panel comprising:
a panel body having a substantially plate shape; and
a curled portion (i) provided at at least a portion of an outer edge of the panel body and (ii) curved in an arc shape,
the back panel being configured to be part of a back frame of a vehicle seat.

2. The back panel according to claim 1, further comprising
a connecting portion (i) connecting the curled portion with the panel body and (ii) curved in a front-rear direction of the vehicle seat.

3. The back panel according to claim 2, wherein:
the connecting portion is curved in an arc shape; and
a hypothetical tangent circle tangent to the curled portion and the connecting portion has a radius larger than a radius of curvature of the curled portion and a radius of curvature of the connecting portion.
